(19) United States
(12) Patent Application Publication
(10) Pub. No.: US 2004/0226186 A1
(43) Pub. Date: Nov. 18, 2004

(54) Apparatus for drying semiconductor substrates using azeotrope effect and drying method using the apparatus

(75) Inventors: Sang-Mun Chon, Gyeonggi-Do (KR); Jin-Sung Kim, Gyeonggi-Do (KR); Pil-Kwon Jun, Gyeonggi-Do (KR); Sang-Oh Park, Gyeonggi-Do (KR); Yong-Kyun Ko, Gyeonggi-Do (KR); Kwang-Shin Lim, Gyeonggi-Do (KR); Hun-Jung Yi, Gyeonggi-Do (KR)

Correspondence Address: MARGER JOHNSON & MCCOLLOM PC, 1030 SW MORRISON STREET, PORTLAND, OR, 97205, US

(73) Assignee: Samsung Electronics Co., Ltd., Suwon-city (KR)

(21) Appl. No.: 10/876,345

(22) Filed: Jun. 23, 2004

Related U.S. Application Data
(62) Division of application No. 10/458,341, filed on Jun. 9, 2003.

(30) Foreign Application Priority Data
Jul. 22, 2002 (KR) 2002-42851

(51) Int. Cl. F26B 3/00

(52) U.S. Cl. 34/467

(57) ABSTRACT

An apparatus of drying semiconductor substrate using azeotrope effect and a drying method using the apparatus are provided. The apparatus includes a bath for storing a fluid, a chamber located above the bath and an apparatus for supplying an organic solvent onto the surface of the fluid in the bath for forming an azeotrope layer at the surface of the fluid and for forming an organic solvent layer over the azeotrope layer. The organic solvent layer and the atmosphere thereon are heated by a heater. The apparatus may further include a drying gas conduit for introducing a drying gas into the chamber.

This application is a divisional of U.S. Pat. No. 10/458,341, filed on Jun. 9, 2003, now pending, which is herein incorporated by reference in its entirety.

### BACKGROUND OF THE INVENTION

1. Field of the Invention

The present invention relates to an apparatus for drying semiconductor substrates and drying method using the same and, more particularly, to an apparatus for drying semiconductor substrates using azeotrope effect and drying method using the apparatus.

2. Description of Related Art

Wet processes such as wet cleaning processes or wet etching processes are very frequently used in the fabrication of semiconductor devices. These wet processes are typically followed by rinsing and drying processes which remove the chemical solution used in the wet processes. De-ionized water (DI water) can be used in the rinse process.

Recently, the Marangoni principle has been widely used in the drying process of semiconductor devices in order to maximize drying efficiency. A drying method and a drying apparatus employing the Marangoni principle are described in U.S. Pat. No. 5,884,640 to Fishkin et al. According to Fishkin et al., DI water in a reservoir is exhausted through a valve installed at an outlet of the reservoir during the dry process. Also, the valve is controlled by a fluid level control system. Accordingly, there is a need to precisely control the accuracy of the operation valve in order to gradually lower the fluid level in the reservoir.

In addition, a Japanese laid-open Pat. No. 10-335299 discloses a wafer drying apparatus using the Marangoni principle. According to the Japanese laid-open Pat. No. 10-335299, the wafer drying apparatus includes an airtight bath capable of producing a sealed vapor space above the DI water in which the semiconductor wafers are dipped. Thus, the dry process is performed by introducing a drying gas into the sealed vapor space. In this case, the drying gas is supplied under high pressure in order to control the lowering of the surface level of the DI water. Accordingly, there is a need to accurately control the pressure of the drying gas in order to control the gradual lowering of the DI water level.

The drying method using the Marangoni principle is very effective in drying a semiconductor substrate having a flat surface. However, there are limitations in drying a semiconductor substrate surface having recessed regions, such as contact holes, and particularly narrow and deep recessed regions. DI water present in these recessed regions may not be fully removed even though the Marangoni principle is applied during the drying process. As a result of the drawbacks of the above prior art drying methods, the residual water located in the above-described recessed regions may generate surface defects called “watermarks.” If the watermarks are formed on the surface of the substrate, the product yields may be significantly decreased.

### SUMMARY OF THE INVENTION

It is therefore a feature of the invention to provide a drying apparatus that is suitable for efficiently removing water on semiconductor substrates.

It is another feature of the invention to provide a drying method, which is capable of efficiently removing water on semiconductor substrates.

According to an aspect of the invention, a drying apparatus is provided. An apparatus of drying semiconductor substrates using an azeotrope effect and a drying method using the apparatus are provided. The apparatus includes a bath for storing a fluid, a chamber located above the bath and an apparatus for supplying an organic solvent onto the surface of the fluid in the bath for forming an azeotrope layer at the surface of the fluid and for forming an organic solvent layer over the azeotrope layer. A heater thereon heats the organic solvent layer and the atmosphere. The apparatus may further include a drying gas conduit for introducing a drying gas into the chamber.

The apparatus for supplying an organic solvent or a distributor is located in the sidewall of the chamber. The organic solvent may be supplied in a gaseous or liquid state. Also, the heater is located in a sidewall of the heater and is preferably located at a higher level than the distributor. The drying gas conduit is preferably located under a lid of the chamber.

Volume concentration (Vol. %) of the organic solvent contained in the organic solvent layer is preferably higher than that of the organic solvent contained in the azeotrope layer. Also, it is preferable that the organic solvent layer and the atmosphere over the organic solvent layer be heated up to a higher temperature than a boiling point of the azeotrope layer. In addition, the fluid may correspond to DI water, which is widely used in the rinse process of the semiconductor substrate, and the organic solvent may be isopropyl alcohol. In this case, the azeotrope layer is a mixture of the DI water and the isopropyl alcohol. Here, the azeotrope layer is a mixture that maintains the most stable state and is composed of 10 Vol. % of the DI water and 90 Vol. % of the isopropyl alcohol. The azeotrope layer of the DI water and the isopropyl alcohol has a boiling point of 80 degrees Celsius.

In the meantime, the organic solvent layer contains the isopropyl alcohol having a volume concentration of which is higher than 90 Vol. %. Accordingly, the boiling point of the isopropyl alcohol layer is higher than 80 degrees Celsius. It has been widely known that in the event that the isopropyl alcohol is heated to evaporate, the amount of evaporated DI water is larger than the amount of evaporated isopropyl alcohol. Thus, if the semiconductor substrate immersed in the DI water is lifted or moved up and a surface of the semiconductor substrate passing through the azeotrope layer and isopropyl alcohol layer is heated, the concentration of the water that remains on the semiconductor substrate is lowered. When the semiconductor substrate is lifted to reach in the chamber, the water on the substrate may be almost completely removed. In particular, the invention is very effective in removing water that exists on the surface of a semiconductor substrate having patterns such as contact holes.

Furthermore, an upper fluid supply conduit may be disposed in an upper sidewall of the wet bath. The upper fluid supply conduit continuously supplies a fresh fluid, e.g., fresh DI water beneath the azeotrope layer while the semiconductor substrate in the wet bath is moved up. In this case, the fluid in the wet bath is preferably drained through an exhaust line, extending from the wet bath. Therefore, a downward stream of the fluid occurs in the wet bath. As a result, a contaminated azeotrope and fluid as well as particles adsorbed on the semiconductor substrate are continuously drained through the exhaust line, thereby further improving the cleaning efficiency. This cleaning is called “drag cleaning”. The organic solvent is continuously supplied from the distributor during the drag cleaning. Accordingly, a fresh azeotrope layer is always formed at the surface of the fluid.

A lower fluid supply conduit may be additionally located in the base of the wet bath. Fresh fluid, such as the DI water also may be supplied into the wet bath through the lower fluid supply conduit prior to ejection of the organic solvent. Thus, it is possible to rinse the semiconductor substrate loaded into the wet bath.

According to another aspect of the invention, a method of drying semiconductor substrates is provided. The method comprises supplying DI water in a bath and introducing or dipping a semiconductor substrate into a fluid, e.g., DI water. An organic solvent is supplied at a surface of the DI water. Accordingly, an azeotrope layer of the DI water and the organic solvent is formed at the surface of the DI water, and an organic solvent layer is formed over the azeotrope layer. The semiconductor substrate is lifted or moved up to pass through the azeotrope layer and the organic solvent layer. In the event that the organic solvent is isopropyl alcohol, the azeotrope layer is a mixture of the DI water and the isopropyl alcohol. In this case, volume ratio of the DI water to the isopropyl alcohol is about 1:9. Also, volume concentration (Vol. %) of the isopropyl alcohol contained in the organic solvent layer is higher than about 90 Vol. %. Thus, volume concentration of the DI water in the fluid on the semiconductor substrate passing through the azeotrope layer and the organic solvent layer become lower than about 10 Vol. %.

Subsequently, the semiconductor substrate passing through the azeotrope layer and the organic solvent layer is heated up to evaporate the fluid that exists on the substrate. As a result, the evaporating amount of the DI water contained in the fluid on the substrate passing through the azeotrope layer and the organic solvent layer is larger than the evaporating amount of the isopropyl alcohol contained therein. Thus, if the organic solvent is continuously supplied and the substrate over the azeotrope layer is continuously heated, the DI water on the substrate is removed. A drying gas is supplied at the surface of the substrate after moving up the substrate from the organic solvent layer. Then, the organic solvent existing on the substrate is removed.

Preferably, fresh DI water is continuously supplied under the azeotrope layer during the supply of the organic solvent and the lifting of the substrate. Further, it is preferable that the DI water in the wet bath be continuously drained through an exhaust line extending from the base of the wet bath. Thus, contaminated DI water and contaminated azeotrope in the wet bath also are drained through the exhaust line. As a result, since a downward stream of the DI water occurs in the wet bath, a “drag cleaning” effect can be additionally obtained. The organic solvent is continuously supplied during the drag cleaning. Accordingly, a fresh azeotrope layer is always produced at the surface of the DI water, and a fresh organic solvent layer is always generated over the fresh azeotrope layer.

In addition, it is preferable that at least the organic solvent be continuously supplied and the fluid in the wet bath is drained through the exhaust line during the supply of the drying gas. Therefore, the DI water remaining in the wet bath may be replaced with the organic solvent.

Furthermore, it is preferable that the drying gas be continuously supplied even after draining the fluid in the wet bath. Thus, it is possible to almost completely remove the organic solvent that exists in the bath and on the substrate.

### BRIEF DESCRIPTION OF THE DRAWINGS

Other features and advantages of the present invention will be more readily understood from the following detailed description of specific embodiments thereof when read in conjunction with the accompanying drawings, in which:

FIG. 1 is a graphical representation of the vaporization properties of an aqueous isopropyl alcohol solution;

FIG. 2 illustrates a schematic view of a drying apparatus in accordance with an exemplary embodiment of the present invention;

FIGS. 3 to 8 are schematic views for sequentially illustrating a drying method in accordance with an exemplary embodiment of the present invention; and

FIG. 9 is a schematic view for illustrating a drying mechanism according to the present invention.

### DESCRIPTION OF THE PREFERRED EMBODIMENT

The preferred embodiments of the present invention will now be described more fully hereinafter with reference to the accompanying drawings. The present invention may, however, be embodied in different forms and should not be construed as limited to the embodiments set forth herein. Rather, these embodiments are provided to more fully convey the scope of the invention. Like numbers in the drawings refer to like elements throughout the specification.

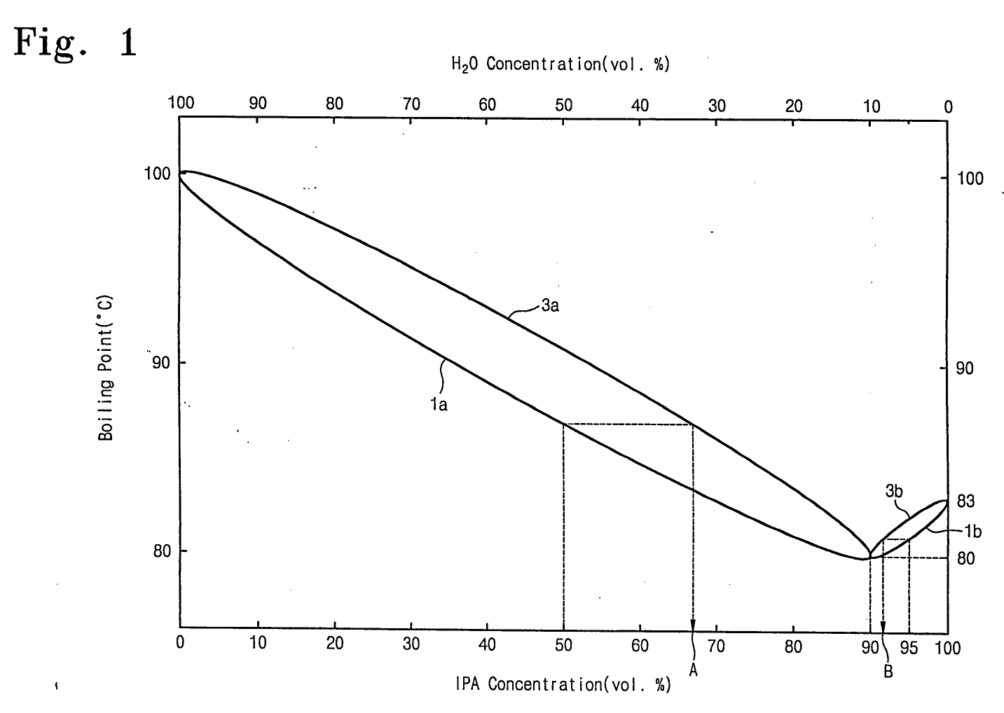

FIG. 1 is a graphical representation of the vaporization properties of an aqueous isopropyl alcohol (IPA) solution. IPA is one of the organic solvent solutions used in the present invention. In the graphical representation of FIG. 1, the two abscissas represent volume concentrations (Vol. %) of IPA and DI water, respectively, and the ordinate represents a boiling point according to the volume concentration of the IPA solution (or the DI water).

Referring to FIG. 1, the IPA solution is a mixture of the DI water and the IPA. An azeotrope mixture of the IPA solution at about 10 Vol. % of the DI water and about 90 Vol. % of the IPA is shown in FIG. 1. A boiling point of the IPA azeotrope mixture is at about 80 degrees Celsius is shown in FIG. 1. Even if the IPA azeotrope mixture is evaporated, the concentration of the evaporated IPA gas is always equal to the concentration of the IPA azeotrope mixture. However, in the event that the IPA solution having an IPA concentration which is higher or lower than 90 Vol. % is evaporated, the concentration of the evaporated IPA gas is different from that of the IPA solution. This is because the boiling point of the IPA solution is lower than its evaporation point when the concentration of the IPA solution is lower or higher than 90 Vol. %, as shown in FIG. 1. In the graph of FIG. 1, first curves 1a and 1b indicate the boiling points of the IPA solutions, and second curves 3a and 3b indicate the evaporation point of the IPA solutions.

For example, when the temperature of the IPA solution having a concentration of 50 Vol. % reaches its boiling point along the first curve 1a of FIG. 1, the IPA solution begins to boil and the IPA contained in the IPA solution evaporates more than the water contained therein. Accordingly, the IPA volume concentration (A of FIG. 1) of the evaporated IPA gas becomes higher than 50 Vol. %. As a result, the water volume concentration of the boiling IPA solution becomes higher than 50 Vol. %.

When the temperature of the IPA solution having a concentration within the range of 90 Vol. % to 100 Vol. %, for example, 95 Vol. % reaches the boiling point thereof along the first curve 1b of FIG. 1, the IPA solution also starts to boil and evaporate. In this case, however, the IPA volume concentration (B of FIG. 1) of the evaporated IPA gas becomes lower than 95 Vol. %. In other words, the water volume concentration of the evaporated IPA gas becomes higher than 5 Vol. %. As a result, the water concentration of the boiling IPA solution is increased over 5 Vol. %.

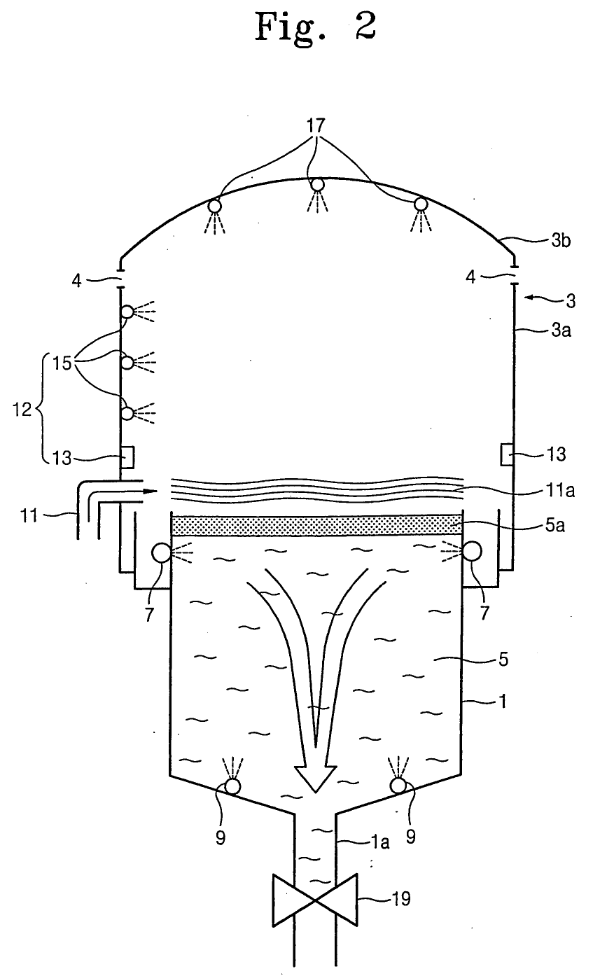

Referring to FIG. 2, a wet bath 1 is provided. The wet bath 1 stores fluid 5 such as de-ionized water (DI water). A chamber 3 is installed over the wet bath 1. The chamber 3 includes a sidewall 3a defining upper and lower openings and a lid 3b covering the upper opening. Thus, a space surrounded by the chamber 3 is provided over the fluid 5 stored in the wet bath 1. A distributor 11 is located adjacent to the upper sidewall of the wet bath 1. The distributor 11 may be installed in the sidewall 3a of the chamber 3. The distributor 11 supplies an organic solvent to the surface of the fluid 5. If the organic solvent is supplied through the distributor 11, a stable azeotrope layer 5a is formed at the surface of the fluid 5, and an organic solvent layer 11a is formed over the azeotrope layer 5a. When the fluid 5 is DI water and the organic solvent is IPA, an IPA azeotrope layer is formed at the surface of the DI water 5. The IPA azeotrope layer is composed of IPA having a concentration of 90 Vol. % and DI water having concentration of 10 Vol. %. The organic solvent can be supplied in a gaseous or liquid state. The concentration of the organic solvent supplied through the distributor 11 is preferably higher than about 90 Vol. %.

A heater 12 is disposed over the distributor 11. The heater 12 is installed at the sidewall 3a of the chamber 3, thereby heating the atmosphere inside the chamber 3. In further detail, if semiconductor substrates (not shown) dipped in the fluid 5 are lifted toward the inner space of the chamber 3, the heater 12 heats the fluid on the semiconductor substrates to evaporate the water in the remaining fluid. Preferably, the heater 12 comprises at least one infrared lamp 13 located over the distributor 11, and at least one hot gas supply conduit 15 located over the infrared lamp 13. Alternatively, the heater 12 may comprise only one of the infrared lamp 13 and the hot gas supply conduit 15. The hot gas supply conduit 15 produces an inert gas heated to a temperature, which is higher than the boiling point of the azeotrope layer, for example, a hot nitrogen gas.

Predetermined regions of the sidewall 3a have exhaust openings 4. Even though the organic solvent and the hot nitrogen gas are introduced into the chamber 3, the pressure in the chamber 3 is kept at 1 atmospheric pressure due to the presence of the exhaust openings 4. The exhaust openings 4 are preferably located at upper portions of the sidewall 3a as shown in FIG. 2. Drying gas conduits 17 are located under the lid 3b. The drying gas supplied from the drying gas conduits 17 removes the organic solvent existing on the surfaces of the semiconductor substrates in the chamber 3. The drying gas may be a nitrogen gas.

The drying apparatus according to the embodiment of the present invention may further comprise an upper fluid supply conduit 7, which is installed at the upper sidewall of the wet bath 1. Also, the drying apparatus may further comprise an outlet conduit 1a, which extends downwardly from the base portion of the wet bath 1. Preferably, fresh fluid, e.g., fresh DI water, is supplied under the azeotrope layer 5a through the upper fluid supply conduit 7 when the organic solvent is supplied through the distributor 1. In this case, the contaminated fluid and the contaminated azeotrope layer in the wet bath 1 are drained through the outlet conduit 1a. Accordingly, a downwardly flowing stream of fluid flows from the wet bath 1, and a “drag cleaning” effect can be obtained. A valve 19 is preferably installed at a predetermined region of the outlet conduit 1a. When the valve 19 is opened, the fluid 5 in the wet bath 1 is drained.

Furthermore, a lower fluid supply conduit 9 may be additionally installed on the base portion of the wet bath 1. The lower fluid supply conduit 9 provides fresh DI water during the rinse process of the semiconductor substrates in the wet bath 1.

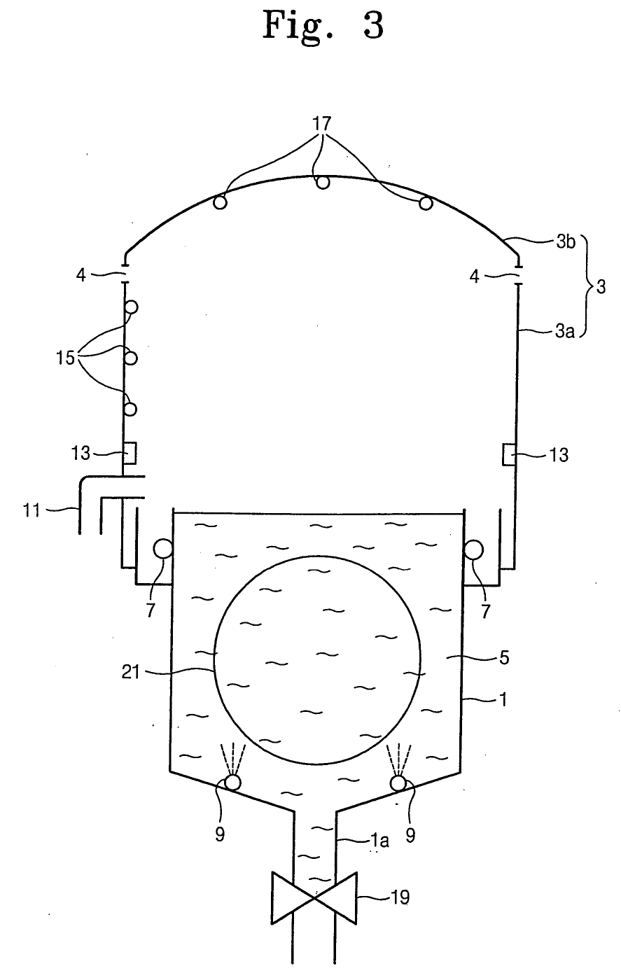

Referring to FIG. 3, a semiconductor substrate 21 is dipped into the DI water 5 in the wet bath 1. Fresh DI water is then continuously supplied into the wet bath 1 through the lower fluid supply conduit 9 to rinse the semiconductor substrate 21. The DI water in the wet bath 1 may overflow during the rinse process.

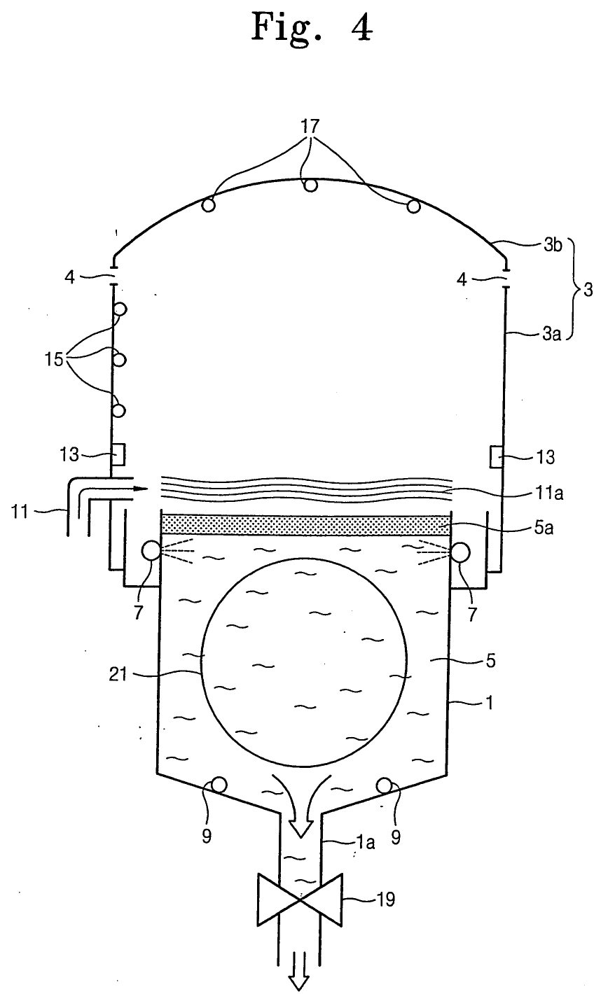

Referring to FIG. 4, the rinse process is followed by supplying organic solvent, i.e., IPA, to the surface of the DI water 5 through the distributor 11. The IPA can be supplied in the gaseous or liquid state. Accordingly, an IPA azeotrope layer 5a is formed at the surface of the DI water 5, and an IPA layer 11a is formed over the IPA azeotrope layer 5a. The concentration of the IPA exiting from the distributor 11 is preferably higher than that of the IPA azeotrope layer 5a. That is, the volume concentration of the IPA contained in the IPA layer 1a is preferably higher than 90 Vol. %.

It is preferable that fresh DI water is continuously supplied into the wet bath 1 through the upper fluid supply conduit 7, and the DI water in the wet bath 1 is drained through the outlet conduit 1a, while the IPA is supplied through the distributor 11. Thus, the contaminated DI water and the contaminated azeotrope in the wet bath 1 are drained through the outlet conduit 1a. Therefore, a “drag cleaning” effect can be obtained. This technique can prevent particles in the DI water 5 from being re-adsorbed onto the surface of the semiconductor substrate 21, and it can also efficiently remove the particles that exist on the surface of the semiconductor substrate 21. Even though the DI water in the wet bath 1 is drained through the outlet conduit 1a, the fresh DI water and the fresh IPA are continuously supplied through the upper fluid supply conduit 7 and the distributor 11, respectively. Thus, a new IPA azeotrope layer is always formed at the surface of the DI water 5, and a new IPA layer 11a is also formed over the new IPA azeotrope layer.

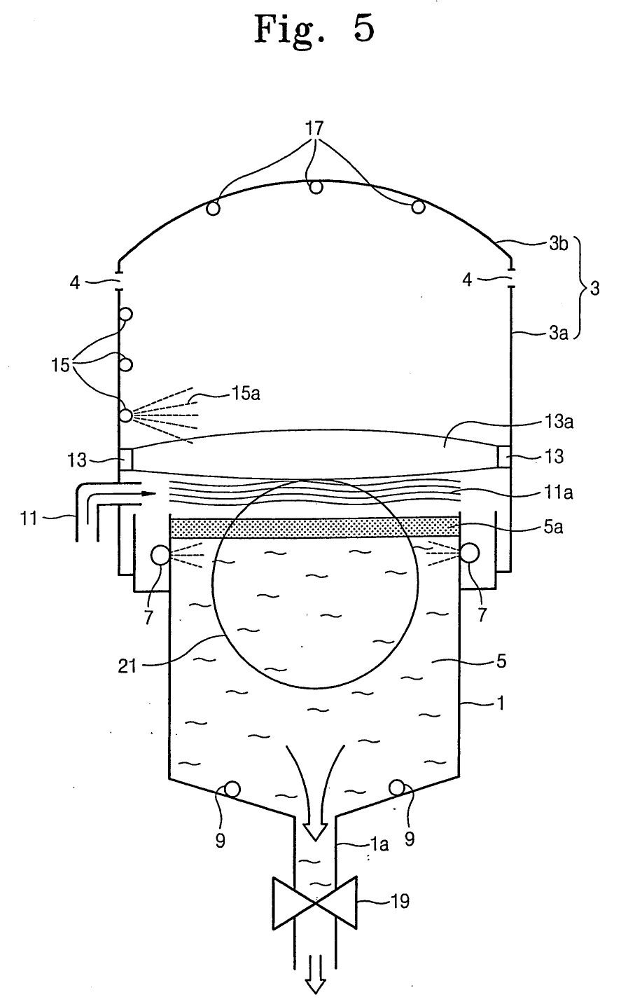

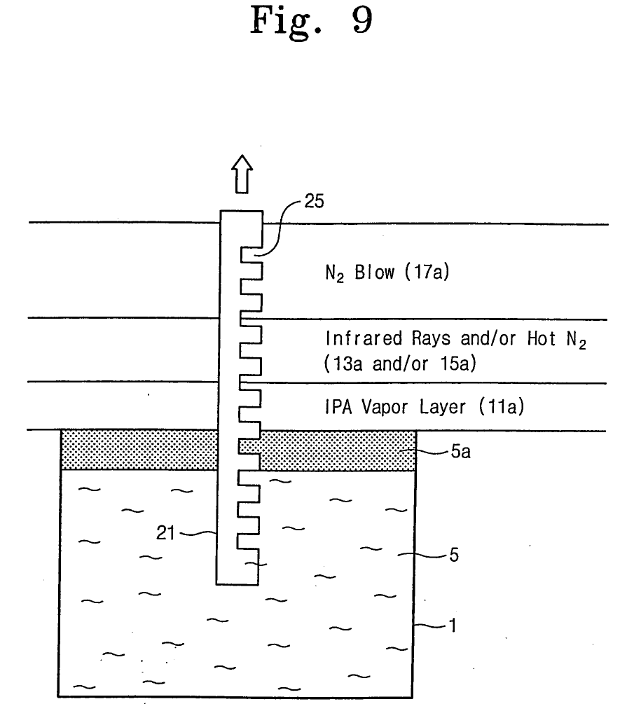

Referring to FIGS. 5 and 9, the semiconductor substrate 21 is slowly lifted while the IPA and the DI water are continuously supplied through the distributor 11 and the upper fluid supply conduit 7, respectively. In addition, the infrared lamp 13 is turned on to irradiate the IPA layer 11a using infrared rays 13a, and a hot nitrogen gas 15a is introduced into the chamber 3 through the hot gas supply conduit 15. While the semiconductor substrate 21 is passing through the IPA azeotrope layer 5a, the DI water on the surface of the semiconductor substrate 21 is replaced with the IPA azeotrope. As a result, the concentration of the remaining DI water on the substrate 21 passing through the IPA azeotrope layer 5a is reduced from 100 Vol. % to about 10 Vol. %.

Subsequently, the concentration of the DI water on the substrate 21 becomes lower than 10 Vol. %, while the substrate 21 is passing through the IPA layer 11a. Thus, a surface tension difference exists on the substrate 21. This is due to the concentration difference of the IPA. As a result, a drying process is performed based on the Marangoni principle. However, even though the drying process based on the Marangoni principle is applied to a patterned substrate having recessed regions 25 such as contact holes as shown in FIG. 9, it is difficult to completely remove the DI water from the recessed regions 25.

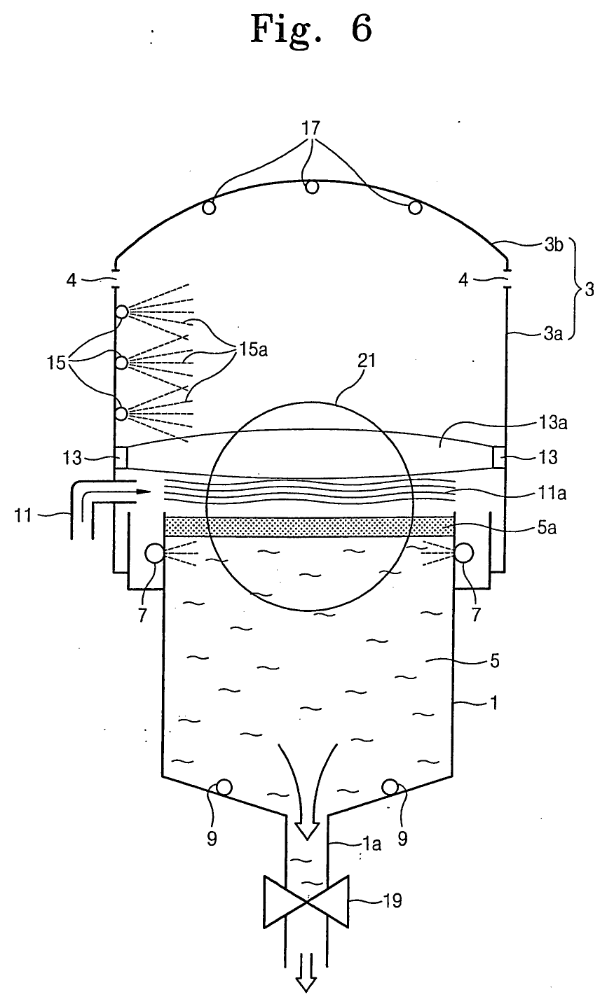

Referring to FIGS. 6 and 9, the surface of the substrate 21 over the IPA layer 1 a is heated by the infrared rays 13a and the hot nitrogen gas 15a. Therefore, the temperature of the remaining IPA on the substrate 21 is raised to the boiling point of the IPA, and the IPA begins to boil. At this time, the concentration of the remaining IPA on the substrate 21 is higher than 90 Vol. %. Thus, the DI water existing on the substrate 21 is almost completely evaporated by heating the remaining IPA on the substrate 21 passing through the IPA layer 11a using the heater, as described with reference to FIG. 1. As a result, only IPA is left on the surface of substrate 21. In particular, when the IPA solution having a concentration higher than 90 Vol. % is evaporated, the DI water in the recessed regions 25 can be effectively removed. During the heating process, fresh DI water is continuously supplied into the wet bath 1 through the upper fluid supply conduit 7, and the contaminated DI water and the contaminated azeotrope in the wet bath 1 are drained through the outlet conduit 1a.

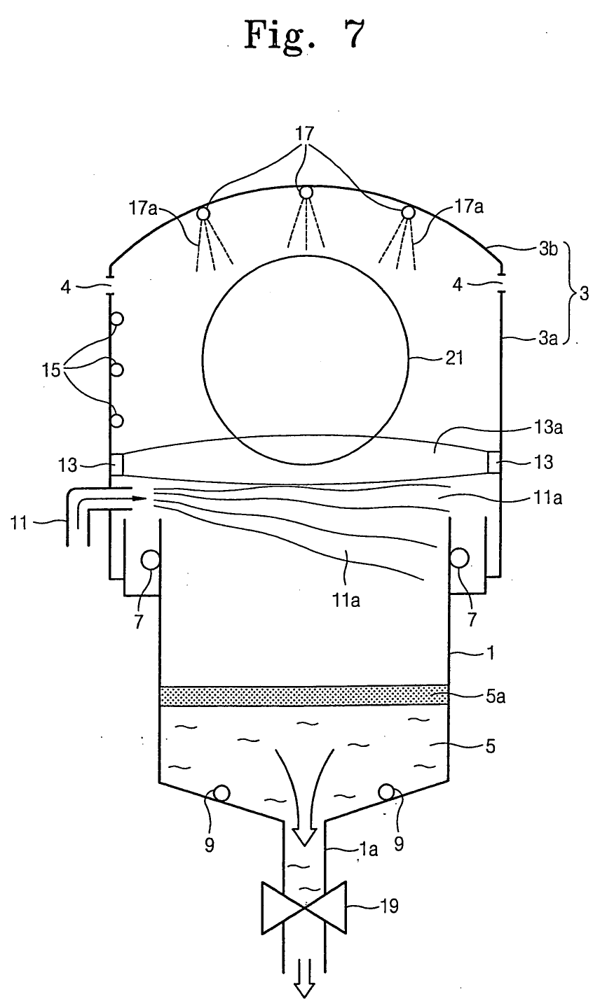

Referring to FIGS. 7 and 9, the heating process is continuously performed to almost completely remove the DI water that remains on the entire surface of the substrate 21 until the substrate 21 is completely lifted. A drying gas 17a, e.g., a nitrogen gas, is then introduced into the chamber 3 through the drying gas conduit 17. Accordingly, the IPA remaining on the substrate 21 is removed. Preferably, the IPA and the infrared rays 13a are continuously supplied to replace the DI water on the inner wall of the chamber 3 with the IPA during injection of the drying gas. Further, it is preferable that the DI water in the wet bath 1 is drained through the outlet conduit 1a, without supply of the DI water through the upper fluid supply conduit 7, during injection of the drying gas.

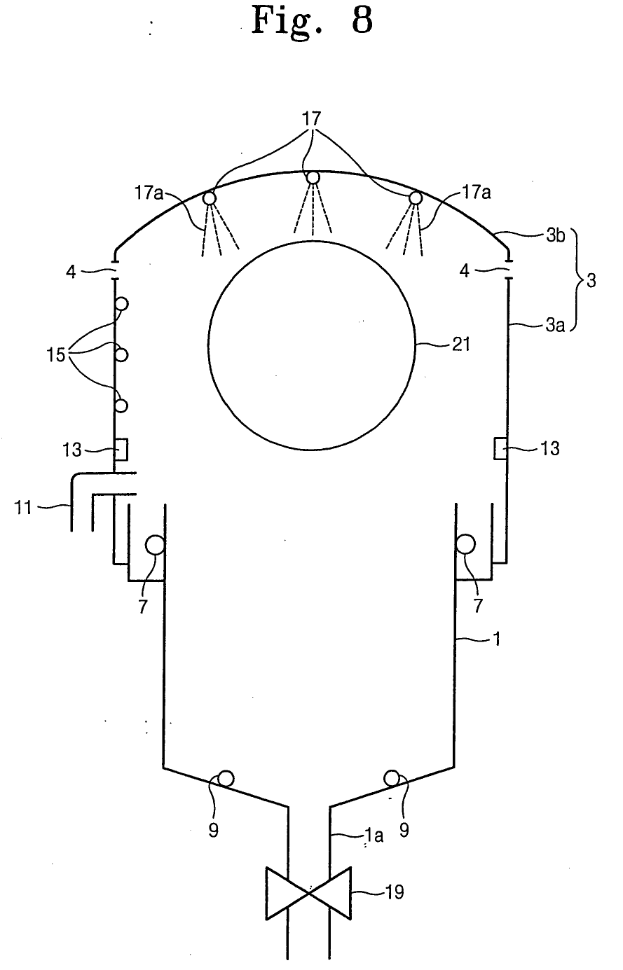

Referring to FIGS. 8 and 9, after the DI water in the wet bath 1 is drained, only the drying gas is supplied to remove IPA that still exists in the chamber 3 and the wet bath 1.

The present invention is not limited to the embodiments as described above and may be embodied in different forms by those skilled in the art. For example, the organic solvent may further comprise ethylglycol, 1-propanol, 2-propanol, tetrahydrofurane, 4-hydroxy-4-methyl-2-pentamone, 1-butanol, 2-butanol, methanol, ethanol, acetone, n-propyl alcohol or dimethylether, instead of the IPA.

According to the present invention as described above, it is possible to effectively remove DI water existing on a patterned semiconductor substrate as well as a flat semiconductor substrate by heating the substrate that passes through an azeotrope layer and an organic solvent layer having higher concentration than the azeotrope layer. Therefore, it can prevent surface defects such as watermarks from being generated at the surface of the substrate after drying process.

While the present invention has been particularly shown and described with reference to the preferred embodiment thereof, the present invention is not restricted to the above embodiment. Further, it will be understood by those skilled in the art that various changes in form and details may be made without departing from the spirit and scope of the invention as defined by the appended claims.

What is claimed is:

1. A method of drying a semiconductor substrate comprising:
introducing the semiconductor substrate into a fluid;
supplying an organic solvent onto the surface of the fluid to form an azeotrope layer at the surface of the fluid and to further form an organic solvent layer over the azeotrope layer;
lifting the semiconductor substrate through the fluid, the azeotrope layer, and the organic solvent layer;
heating the semiconductor substrate as it passes through the organic solvent layer for removing the fluid that remains on the surface of the semiconductor substrate; and
treating the surface of the semiconductor substrate with a drying gas to remove an organic solvent that remains on the surface of the semiconductor substrate after the semiconductor substrate is lifted through the organic solvent layer.

2. The method of claim 1, which further comprises rinsing the semiconductor substrate prior to supplying the organic solvent.

3. The method of claim 2, wherein rinsing the semiconductor substrate is performed by continuously introducing a fluid, the supply of the fluid being stopped after the rinsing process of the semiconductor substrate has been completed.

4. The method of claim 1, wherein the organic solvent is isopropyl alcohol, the isopropyl alcohol is supplied in a vapor or a liquid state.

5. The method of claim 4, wherein volume concentration of the isopropyl alcohol contained in the organic solvent layer is higher than that of the isopropyl alcohol contained in the azeotrope layer.

6. The method of claim 1, further comprises continuously supplying the fluid under the azeotrope layer, while the organic solvent is supplied and the semiconductor substrate is lifted, the fluid under the azeotrope layer being drained thereby generating a downward stream of the fluid.

7. The method of claim 1, wherein heating a surface of the semiconductor substrate passing through the organic solvent layer further includes irradiating infrared rays onto the surface of the semiconductor substrate.

8. The method of claim 1, wherein heating a surface of the semiconductor substrate passing through the organic solvent layer comprises:
irradiating infrared rays onto the surface of the semiconductor substrate; and
supplying an inert gas, heated to a higher temperature than the boiling point of the azeotrope layer, onto the surface of the semiconductor substrate that passes through the infrared rays.

9. The method of claim 1, wherein heating a surface of the semiconductor substrate passing through the organic solvent layer comprises supplying an inert gas heated to a higher temperature than the boiling point of the azeotrope layer onto the surface of the semiconductor substrate that passes through the organic solvent layer.

10. The method of claim 1, wherein the drying gas is a nitrogen gas.

11. The method of claim 1, which further comprises continuously supplying at least the organic solvent and draining the fluid, while the drying gas is supplied.

12. The method of claim 11, which further comprises continuously supplying only the drying gas to remove the remaining organic solvent on the semiconductor substrate, after the fluid is drained.
